(19) United States
(12) Patent Application Publication
(10) Pub. No.: US 2026/0127272 A1
(43) Pub. Date: May 7, 2026

(54) DATA PIPELINE

(71) Applicant: Wells Fargo Bank, N.A., San Francisco, CA (US)

(72) Inventors: Satish Raj Katakam, Exton, PA (US); Ralph Pinheiro, Paoli, PA (US); Umamaheshwari Thandapani, Phoenix, AZ (US)

(21) Appl. No.: 18/934,465

(22) Filed: Nov. 1, 2024

(51) Int. Cl. G06F 21/55; G06F 21/54

(52) U.S. Cl. CPC G06F 21/552; G06F 21/54; H04L 63/302

(57) ABSTRACT

An example computer system for ingesting data from multiple sources. The example computer system comprises one or more processors; and non-transitory computer-readable storage media encoding instructions which, when executed by the one or more processors, causes the computer system to: receive, from a plurality of data sources, data entries, the plurality of data sources including an external computing device and an application programming interface; determine an application for use of the data entries; transform the data entries for storage in a database; curate a history record of the data entries stored in the database; and refine the data entries for use with the application.

### BACKGROUND

Data ingestion is the process of gathering and importing data from various sources into a centralized location, such as a data warehouse, data lake, or database, for further processing and analysis. Ingestions involves collecting raw data from diverse origins, like databases, application programming interfaces (APIs), files, sensors, and social media feeds, and transforming it into a usable format. Further, data ingestion includes steps to produce useable data. Once the data is collected, the data is transformed into a usable format. After the data is transformed, the data can be provided to the target system. However, the variety of data sources results in extensive development effort to process the data.

### SUMMARY

Examples provided herein are directed to data ingestion pipeline.

According to one aspect, an example computer system for ingesting data from multiple sources comprises: one or more processors; and non-transitory computer-readable storage media encoding instructions which, when executed by the one or more processors, causes the computer system to: receive, from a plurality of data sources, data entries, the plurality of data sources including an external computing device and an application programming interface; determine an application for use of the data entries; transform the data entries for storage in a database; curate a history record of the data entries stored in the database; and refine the data entries for use with the application.

According to another aspect, an example method for ingesting data from multiple sources comprises: receiving, from a plurality of data sources, data entries, the plurality of data sources including an external computing device and an application programming interface; determining an application for use of the data entries; transforming the data entries for storage in a database; curating a history record of the data entries stored in the database; and refining the data entries for use with the application.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system including a data ingestion pipeline.

FIG. 2 shows example logical components of a server device of the system of FIG. 1.

FIG. 3 shows additional details of the example server device of FIG. 2.

FIG. 4 shows a method for ingesting data with the system of FIG. 1.

FIG. 5 shows example physical components of the server device of FIG. 2.

### DETAILED DESCRIPTION

This disclosure relates to a data ingestion pipeline. Data ingestion and processing allows organizations to harness the power of their data, regardless of its source or format, and improve business value and innovation. For example, acquired data from outside sources can be input into analytics platforms, which enables organizations to gain insights about the data. The insights may indicate customer behavior, preferences, or other information about the organization's business. In addition, processing data can be used to train machine learning models for artificial intelligence. The data can also be used for cyber security analysis. Cyber security analysists can use the data for threat detection, prevention, and response. Ingested data can also be stored in repositories as historical data and current data. The repositories may be data warehouses or data lakes.

While acquiring data for these purposes can have valuable purposes, data from external sources is often in a format that is unusable by internal systems of the organization or entity. For example, the data may need to be cleaned, converted, and/or transformed before use. Thus, the data must be processed before it can be stored, analyzed, or used for other purposes. Ingestion and processing to provide usable data can consume extensive resources and take considerable amounts of time.

The present disclosure provides a data ingestion pipeline (DPL). Embodiments of the DPL can be implemented in a DPL system that provides a modern, well-managed, and easy-to-use data ecosystem for cyber security analysts, data scientists, incident responders, and threat hunters to self-serve analytical data to support accelerated threat detection, prevention and response, and to confidently secure and protect customers and assets.

Further, data can be quickly ingested with little to no development effort. Further, the DPL system utilizes multiple knobs that can be tuned based on ingestion type and use case. Knobs refer to configurable parameters or settings that influence the behavior and performance of a system or process. Further, the knobs allow for fine-tuning of various aspects of how data is handled. In some embodiments, the DPL system uses a Yet Another Markup Language (YAML).

The DPL system also manages access to each set of data. For example, the DPL system may support domain-based data access. Each domain may have its own service account to operate on its own data stored within the DPL system. In some embodiments, cross-domain data access is supported based on data needs. The cross-domain data may require approvals from different domains or accounts. Managing access enables reception of data from multiple external sources such as an API or external databases.

In some embodiments, the DPL system provides a low code solution using Apache airflow/Apache Spark for building data pipelines using YAML based configuration. The DPL system further provides an automation of data quality controls (technical and business controls) to achieve data completeness and accuracy.

In some embodiments, the DPL system also provides ingestion-based metrics. The metrics may be based on specified control procedures. Further, the DPL system automates data controls needed to maintain the quality of data ingested into a data lake. Business rules may also be implemented in the DPL system. The business data quality rules can be configured in YAML, and the rules can be run in an automated fashion. Higher quality data allows for faster processing of data from multiple sources.

Embodiments of the present disclosure can democratize cyber security and analytical data for access and management of an entity's stored data. The DPL system also implements a federated model where a user can onboard, discover, reuse, shape and consume self-describing, trustworthy, and highly reliable analytical data applied to diverse analytical uses. Further, users can access the system and use the data to perform specified tasks while the DPL system automatically enforces data standards and controls.

The DPL system provides automated consumption/ingestion of data from multiple data sources and storage in a central database (e.g., a data lake). As a result of the efficient data ingestion from multiple data sources, the DPL system reduces costs and improves time to market of products since user devices can more efficiently access and process the data in a useful manner with less difficulty.

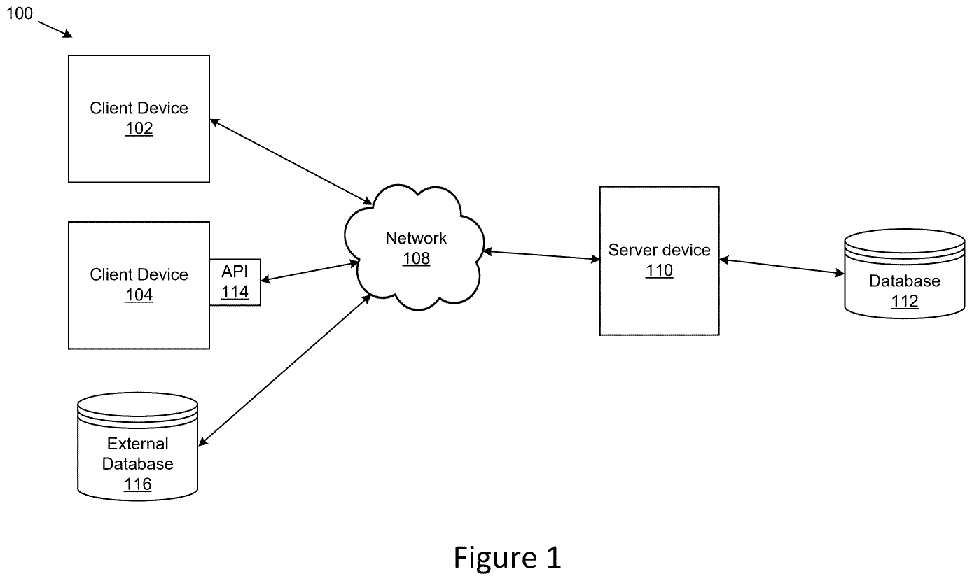

FIG. 1 schematically shows aspects of one example system 100 programmed to provide LLM agents. The system 100 is a DPL system. In this embodiment, the system 100 includes a server device 110 that connects to a database 112. The server device 110 connects through a network 108 to a client device 102, a client device 104, and an external database 116. The client device 104 also connects to the server device 110 using an API 114.

The system 100 can be used to ingest and process data. Data from each of the client device 102, the client device 104, and the external database 116 can be received by the server device 110. The server device can ingest the data and process the data so that is in a usable format. The data may then be stored in the database 112. The stored data can then be accessed for purposes such as cyber security. The data is provided in a format that is usable by any internal device, such as the client device 102 or the client device 104, of the entity that controls the server device 110.

The server device 110 receives data through the network 108 from the client device 102, the client device 104, and the external database 116. The data may be structured data and/or in JavaScript Object Notation (JSON). Once received, the server device 110 processes the data. The data may be in the form of a control file. The control file includes metadata that describes the data itself. For example, the control file may include a name of the control file, the data contents, number of records, or other metadata.

In some embodiments, the server device 110 uses YAML to provide configuration schema. YAML uses simple syntax to represent complex data structures. The configuration schema instructs the server device 110 regarding how to process the incoming data. For example, the server device 110 may validate row count, which includes checking if the row count matches a specified number of rows in the configuration schema. Ingestion may include different configuration schemas for data from different sources. In some embodiments, the configuration schema includes a specified location to pull data. The location may be a list of tables to pull to acquire data. In some embodiments, the configuration schema can specify a number of parallel threads for the server device 110 to execute to ingest and retrieve data from the database 112. In some embodiments, the server device 110 provides alerts based on ingesting the data or validating the data.

The server device 110 also curates the file for storage in the database 112. For example, the server device 110 may map the data from its source location onto a cluster within the database 112. In some embodiments, the server device 110 uses SparkOperator of Apache Airflow to ingest the data. SparkOperator is an Apache Airflow operator specifically designed to manage the lifecycle of Apache Spark applications within a Apache Airflow cluster.

The server device 110 also refines the data before storage. Refinement may include executing specified business rules that further manage quality of the received data and validate the data. The business rules may include evaluating specified columns or rows within the control file for ingested data. If the columns are not a preselected value, then an alert is provided to a user device.

In some embodiments, the server device 110 implements file ingestion. Implementing file ingestion may include controlling the data load, handling varying volumes of data processing throughout a day, delivery control, creation date control, and duplicate feed control.

In some non-limiting examples, the server device 110 is owned by a financial institution, such as a bank. The client device 102 and the client device 104 can be programmed to communicate with the server device 110 to perform various tasks, such as financial transactions. Many other configurations are possible, and the disclosure is not limitation to the financial industry.

The client device 102 and the client device 104 are computing devices that can connect and exchange data with the server device 110. The client device 102 may be an internal device that is controlled by the same entity that controls the server device 110. The client device 102 may have stored files with relevant data for the database 112. Further, the client device 102 may generate data as it performs certain tasks. For example, the client device 102 may create a file with data that is sent to the server device 110 for storage in the database 112. In some embodiments, the client device 102 is a device used for cybersecurity. The client device 102 may access the data stored within the database 112 that has been processed. Due to the efficient ingestion and process, the client device 102 presents the data in a usable manner for a user that needs the data for a threat response or other cybersecurity task.

The database 112 may be any type of database for storing data in a variety of formats. The server device 110 can store and retrieve data from the database 112. In some embodiments, the database 112 is a relational database or a non-relational database. The database 112 may use different languages to retrieve and/or store data such as sequence query language (SQL) or NoSQL.

The API 114 allows for applications of the client device 104 to access the server device 110. In some embodiments, the client device 104 provides data through the API 114. The API 114 may be a representational state transfer (REST) API, which uses hypertext transfer protocol (HTTP). The API 114 may be a different API such as a simple object access protocol (SOAP) API.

Each of the devices may be implemented as one or more computing devices with at least one processor and memory. Example computing devices include a mobile computer, a desktop computer, a server computer, or other computing device or devices such as a server farm or cloud computing used to generate or receive data.

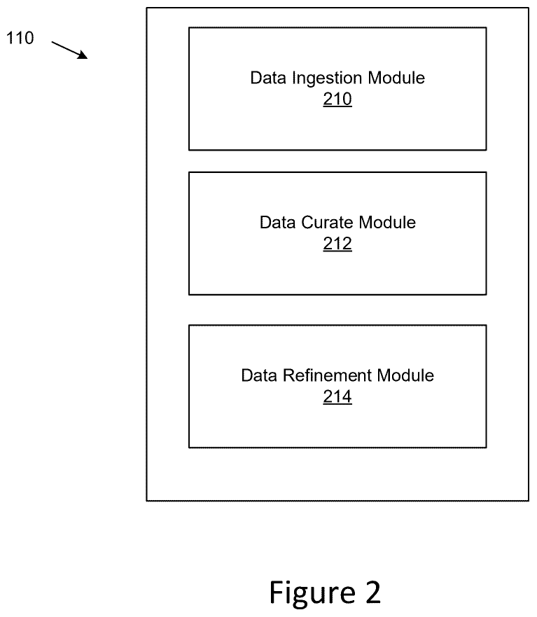

FIG. 2 shows example logical components of the server device 110 of the system 100. In this embodiment, the server device 110 includes a data ingestion module 210, a data curate module 212, and a data refinement module 214.

The data ingestion module 210 receives data from a source and ingests the data. The data ingestion module 210 also controls data receipt. The data ingestion module 210 performs controls automatically to ingest the data. For example, the data ingestion module 210 can confirm safe receipt of the data and successful load into the database 112. In addition, the data ingestion module 210 manages a volume of the received data.

In some embodiments, the data ingestion module 210 may monitor whether the volume of received data exceeds a normal threshold or falls short of a normal threshold, which may be called data completeness management. The normal threshold may be a predetermined range of expected data that is normally received. Additionally, the data ingestion module 210 performs a load control that verifies the received data was successfully loaded in the database 112 or another target application. The load control may also handle exceptions that are encountered from the data entries while ingesting the data.

In some embodiments, the data ingestion module 210 monitors completeness of data uploads. When data is uploaded to the database 112, the data ingestion module 210 checks upload entries to ensure they match the number of record entries received from the source computing device. The data ingestion module 210 also validates that entries of the received data files or feeds are not empty. Additional validation the data ingestion module 210 can perform includes verifying the creation date of the received data that is stored in the database 112 matches the expected creation date from the source file or feed. The data ingestion module 210 also monitors uploaded data files to ensure duplicative files were not uploaded.

In some embodiments, the data ingestion module 210 formats the data for storage in the database 112 or for use in a target application. Data is retrieved from many sources such as the client device 102, the client device 104, and the external database 116. Each of these sources may provide data in different formats. The data ingestion module 210 edits and adjusts the data so the data can be stored in a consistent format and is standardized. Further, each of these functions (or also called controls) can be automated and performed as data is received. The data ingestion module 210 may also log failures to load entries from the client device 102, the API 114, or the external database 116. In some embodiments, the data ingestion module 210 performs a control of data receipt control. Data receipt control includes validating that all target data entries are loaded into an expected location. In some embodiments, the data ingestion module 210 performs different controls based on the source of the received data entries.

In some embodiments, the data ingestion module 210 includes knobs. Knobs are configured to adjust ingestion functions. Based on the data use case, source, or other ingestion parameter, the knobs can adjust how the data ingestion module 210. In some embodiments, the knobs change settings of the previously mentioned functions of the data ingestion module 210. For example, the knobs may adjust tolerances of the volume control or adjust a data load control that handles exceptions when ingesting the data.

In some embodiments, the data ingestion module 210 includes a control for flagging data that is to be transformed. Received data entries may be in an inconsistent format due to being received from multiple sources. The data ingestion module 210 may flag certain data to be transformed before use by an application or storage in the database 112. The flag may be sent to the data refinement module 214 to indicate which data is to be transformed.

The data curate module 212 analyzes the data and provides a historical understanding of the data. For example, the data curate module 212 provides a history of changes for any stored data in the database 112. Further, the data curate module 212 can slowly change dimensions of the stored data files in the database 112 and allow for access to previous versions of the data. The data curate module 212 may add historical context data. The historical context data can be analyzed to see relationships of the ingested data. For example, the data may be related to cyber security events. The data can then be more efficiently analyzed and understood by users so cyber security solutions can be more effectively deployed. Further, past versions of data can be easily accessed. Further, the historical data and relationship data associated with the ingested data allow multiple business units to better understand the data through accumulation and transformation.

In some embodiments, records associated with the ingested data are created. The data curate module 212 adds these records to show a history of the data. In addition, the data curate module 212 can update a record by adding a new version of the record. The data curate module 212 also makes the old record inactive, however, the old record is still viewable to analyze a history of the data or data file. The records create a history for the ingested data. The data curate module 212 provides patterns of changes in the data through the data history. The reports may also be stored in the database 112.

In some embodiments, the data curate module 212 performs data quality functions for ingested data from the data ingestion module. For example, the data curate module 212 may cleanse the data by identifying and correcting errors, inconsistencies, or discrepancies in the data. In some embodiments, the data curate module 212 enriches the data by adding additional metadata to the ingested data.

The data refinement module 214 prepares the data for individual use with specific applications. As previously discussed, the data refinement module 214 executes specified business rules that further manage quality of the received data and validate the data. The data refinement module 214 also accumulates and/or transforms the data. For example, data may be received that indicates how many vulnerabilities were closed in a given day. This data is then transformed so any other device or application can access and use the data. In one example, a data analyst may use the data to determine if there was a larger number of vulnerabilities within an entities system for a given day.

Further, the data refinement module 214 may also perform business logic on the ingested data. Business logic may include ensuring a data entry has a valid result. For example, a particular entry may include a “YES” or “NO” value that should be either 0 or 1. The data refinement module 214 can further transform the data using the business logic so other applications may properly access the data. The data refinement module 214 may receive ingested data from the data curate module 212 or directly from the data ingestion module 210. The data refinement module 214 is then configured to store the refined data in the database 112.

In some embodiments, the data refinement module 214 performs other refinement functions. The data refinement module 214 collects and provides metrics about ingested data. For example, the metrics may indicate cyber security information. The metrics may include number of malicious attempts to access an entity's system, vulnerabilities detected, hack attempts prevented, among additional cybersecurity information. The data refinement module 214 may provide the metrics to another device. The metrics can be used to analyze the security of an entity's internal network.

In some embodiments, the data refinement module 214 enables cross-domain data access. User accounts that are associated with a different domain than originated the data are enabled to use the data for other purposes. For example, the ingested data entries may be related to cyber security. A user account that is associated with data analytics or another domain can access the cyber security data entries and use the data entries within its domain of data analytics.

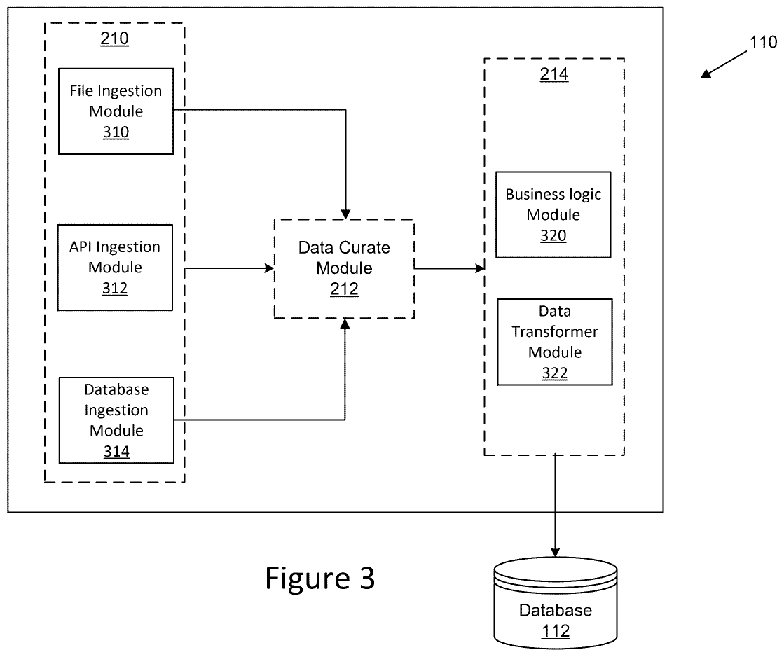

FIG. 3 shows an additional view details of the example server device 110. In this embodiment, the data ingestion module 210 includes a file ingestion module 310, an API ingestion module 312, and a database ingestion module 314 to perform various controls on the received data. The data refinement module 214 also includes a business logic module 320 and a data transformer module 322.

The data ingestion module 210 includes components for receiving data from multiple different source types. The file ingestion module 310 receives data files from the client device 102. Further, the file ingestion module 310 is configured to receive data from file systems stored on internal client devices, such as client device 102. In some embodiments, the file ingestion module 310 receives data files from external devices.

In an example, the file ingestion module 310 checks that the received data file from the client device 102 can be loaded to the target application. This may include comparing data loaded into tables of the database 112 to the source file at the client device 102 and determining if there are discrepancies. The file ingestion module 310 may schedule delivery of data from the client device 102 or determine if the data file from the client device 102 is delivered according to specific parameters. The parameters may be in accordance with a service-level agreement (SLA).

The API ingestion module 312 receives and ingests data from the API 114. The API 114 may stream data as it is created to the API ingestion module 312. In some embodiments, the API ingestion module 312 may capture exceptions found in the data received from the API 114. Further, the API ingestion module 312 ensures that the number of records received within the data are within an expected tolerance to the number of records received in the prior period. Monitoring the amount of data can help prevent overload of the server device 110. Further, receiving more records in a set of data than expected may indicate an anomaly or other type of event. The data ingestion module 210 may provide an alert responsive to the number of records exceeding an amount of a previous period or a predetermined number of records.

The database ingestion module 314 receives and ingests data from the external database 116. The external database 116 may store data that is useful to be moved to an internal database, such as the database 112. The database ingestion module 314 can perform functions to prepare the records within the data from the external database 116 for storage in the database 112.

In some embodiments, the database ingestion module 314 extracts data from the external database 116. The database ingestion module 314 is configured to check the loaded records in tables of the database 112 match the records within tables of the external database 116. In some embodiments, the database ingestion module 314 provides an error if a table of entries from the external database 116 is unable to be loaded into the database 112. For example, the table may be unable to be loaded because it contains a corrupted value or a value that is unable to be read and transferred to the database 112.

In some embodiments, the database ingestion module 314 receives transaction updates to the external database 116 from other applications. The database ingestion module 314 may connect to a change data capture (CDC) module that is located at an external server. The CDC module may connect to the external database 116. Rather than wait for data to be scheduled to be delivered from the external database 116, the database ingestion module 314 receives data records as changes are made to data in the external database 116 in real time.

The business logic module 320 is configured to apply business logic to the ingested data. In some embodiments, the business logic module 320 is configured to receive a set of rules, and the business logic module 320 applies the rules to the ingested data. For example, the business logic module 320 may analyze cyber security data to determine if certain devices are vulnerable to a cyber security attack. The business logic module 320 may flag the indicated data for further investigation of the indicated devices. In some embodiments, the business logic rules are coded in YAML.

The business logic module 320 also automatically executes rules to maintain a high quality of data. For example, the data entries may include data that is inconsistent or outdated. The business logic module 320 can filter data that is outdated or inconsistent. Further, the business logic module 320 may pass the data to the data transformer module 322 for transformation into a consistent format before storage in the database 112.

The data transformer module 322 transforms the ingested data for a particular application. Certain applications require data to be in a particular format, otherwise the application cannot read or use the data. In some embodiments, the data transformer module 322 is configured to determine an application that will use the ingested data entries. Responsive to determining the application, the data transformer module 322 transforms the data for use with the determined application. In some embodiments, the data transformer module 322 receives an indication from the data ingestion module 210 that indicates certain data needs to be transformed before storage in the database 112.

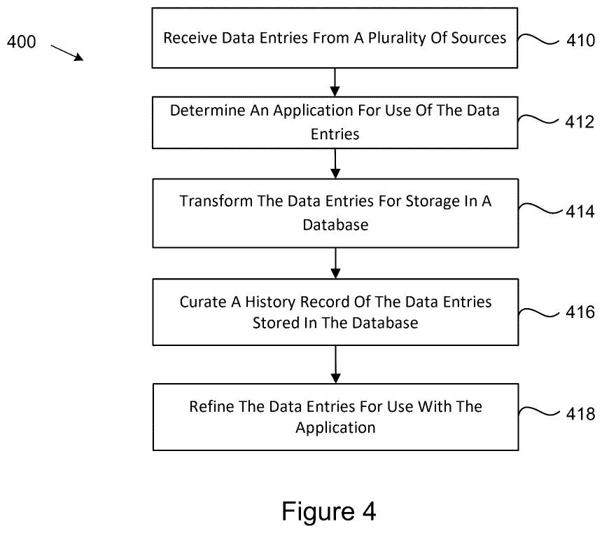

FIG. 4 shows an example method 400 for ingesting data with the system 100. The method 400 includes an operation 410, an operation 412, an operation 414, an operation 416, and an operation 418. Some or all of the indicated operations of the method 400 may be performed by the server device 110. In some embodiments, some operations may be omitted while additional operations not shown are added.

At the operation 410, data entries are received from a plurality of sources. The plurality of sources may include the client device 102, the API 114, or the external database 116. In an example, the data entries are related to cyber security events, such as the number of vulnerabilities closed in a day.

At the operation 412, an application for use of the data entries is determined. In some embodiments, the application is a cyber security application for managing vulnerabilities. The cyber security application is configured to display the vulnerabilities that were closed for the day.

At the operation 414, the data entries are transformed for storage in a database. The database may be the database 112. In some embodiments, transforming the data entries include editing the format to match a storage format of the database. In some embodiments, transforming the data includes validating the data entries.

At the operation 416, a history record of the data entries stored in the database is curated. The history record shows past updates or changes that have been made to the data. The updates may be in response to receiving updates from one of the previously mentioned external devices. For example, cyber security events may change for each day and the data entries are updated. The curated history shows relationships between the old records of the data entries. In some embodiments, the method 400 includes edit a data entry within the database and update the history record of the data entry.

At the operation 418, the data entries are refined for use with the application. For example, the cyber security data may be refined to be compatible with the cyber security application. In some embodiments, refining the data entries includes processing the data with business logic.

In some embodiments, the method 400 includes additional operations. In some embodiments, the method 400 includes providing the data entries to the application. The application is a cyber-security analysis tool. In some embodiments, the plurality of data sources further includes an internal computing system, and the internal computing system is part of an internal network including the computer system. In some embodiments, the method 400 includes responsive to a reception of the data entries, performing controls to ingest the data entries. In some embodiments, the controls include a data receipt control. In some embodiments, the controls include a data completeness management control. In some embodiments, the method 400 includes determining a source for the data entries and selecting a control to ingest the data entries based on a determined source. The method 400 may then include perform a selected control.

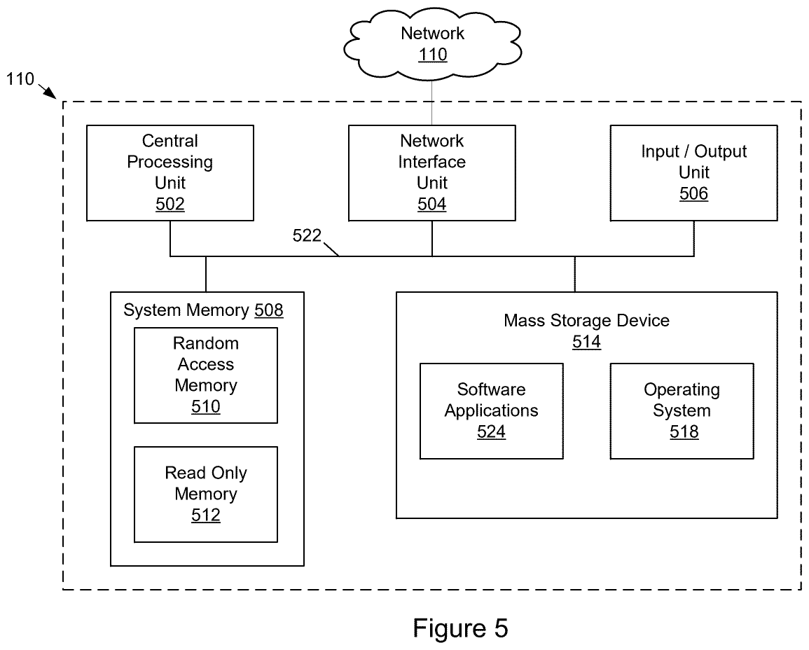

As illustrated in the embodiment of FIG. 5, the example server device 110, which provides at least some of the functionality described herein, can include at least one central processing unit (“CPU”) 502, a system memory 508, and a system bus 522 that couples the system memory 508 to the CPU 502. The system memory 508 includes a random-access memory (“RAM”) 510 and a read-only memory (“ROM”) 512. A basic input/output system containing the basic routines that help transfer information between elements within the server device 110, such as during startup, is stored in the ROM 512. The server device 110 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the server device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 may operate in a networked environment using logical connections to remote network devices through network 108, such as a wireless network, the Internet, or another type of network. The server device 110 may connect to network 108 through a network interface unit 504 connected to the system bus 522. It should be appreciated that the network interface unit 504 may also be utilized to connect to other types of networks and remote computing systems. The server device 110 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the server device 110 can store software instructions and data. The software instructions include an operating system 518 suitable for controlling the operation of the server device 110. The mass storage device 514 and/or the RAM 510 also store software instructions and applications 524, that when executed by the CPU 502, cause the server device 110 to provide the functionality of the server device 110 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for ingesting data from multiple sources, the computer system comprising:
one or more processors; and
non-transitory computer-readable storage media encoding instructions which, when executed by the one or more processors, causes the computer system to:
receive, from a plurality of data sources, data entries, the plurality of data sources including an external computing device and an application programming interface;
determine an application for use of the data entries;
transform the data entries for storage in a database;
curate a history record of the data entries stored in the database; and
refine the data entries for use with the application.

2. The computer system of claim 1, wherein the instructions further cause the computer system to:
provide the data entries to the application, wherein the application is a cyber-security analysis tool.

3. The computer system of claim 1, wherein the instructions further cause the computer system to:
edit a data entry within the database; and
update the history record of the data entry.

4. The computer system of claim 1, wherein the plurality of data sources further includes an internal computing system, the internal computing system being part of an internal network including the computer system.

5. The computer system of claim 1, wherein refining includes processing the data with business logic.

6. The computer system of claim 1, wherein the instructions further cause the computer system to:
responsive to a reception of the data entries, perform controls to ingest the data entries.

7. The computer system of claim 6, wherein the controls include a data receipt control.

8. The computer system of claim 7, where in the controls include a data completeness management control.

9. The computer system of claim 1, wherein the instructions further cause the computer system to:
determine a source for the data entries; and
select a control to ingest the data entries based on a determined source.

10. The computer system of claim 9, wherein the instructions further cause the computer system to:
perform a selected control.

11. A method for ingesting data from multiple sources, the method comprising:
receiving, from a plurality of data sources, data entries, the plurality of data sources including an external computing device and an application programming interface;
determining an application for use of the data entries;
transforming the data entries for storage in a database;
curating a history record of the data entries stored in the database; and
refining the data entries for use with the application.

12. The method of claim 11, further comprising:
providing the data entries to the application, wherein the application is a cyber-security analysis tool.

13. The method of claim 11, further comprising
editing a data entry within the database; and
updating the history record of the data entry.

14. The method of claim 11, wherein the plurality of data sources further includes an internal computing system, the internal computing system being part of an internal network.

15. The method of claim 11, wherein refining includes processing the data entries with business logic.

16. The method of claim 11, further comprising:
responsive to a reception of the data entries, performing controls to ingest the data entries.

17. The method of claim 16, wherein the controls include a data receipt control.

18. The method of claim 16, where in the controls include a data completeness management control.

19. The method of claim 11, further comprising:
determining a source for the data entries; and
selecting a control to ingest the data entries based on determining the source.

20. The method of claim 19, further comprising:
performing a selected control.
